(19) United States
(12) Patent Application Publication
(10) Pub. No.: US 2026/0349529 A1
(43) Pub. Date: Nov. 5, 2026

(54) FOLDABLE KEYBOARD

(71) Applicant: Shenzhen DZH industrial co., ltd, Shenzhen (CN)

(72) Inventor: Dagao Zhou, Beiliu (CN)

(21) Appl. No.: 19/722,351

(22) Filed: Jun. 26, 2026

(30) Foreign Application Priority Data
Feb. 6, 2026 (CN) 202620177077.4

(51) Int. Cl. G06F 3/02

(52) U.S. Cl. CPC G06F 3/0221

(57) ABSTRACT

A foldable keyboard comprises keyboard bodies and shaft arms. Two keyboard bodies are provided, and the two keyboard bodies are arranged opposite to each other, with one of the keyboard bodies located on the right side of the other keyboard body. Two shaft arms are provided, a right end of the left keyboard body is connected to one of the shaft arms, a left end of the right keyboard body is connected to the other shaft arm, and the two shaft arms mesh with each other. Compared with a hinge product using a single axis, the axis point thereof theoretically must be higher than the upper planes of the two bodies to achieve 180-degree rotational folding, causing a shaft housing to protrude and interfere with a user's hand. Meanwhile, due to poor synchronization between the two bodies during folding rotation, an ergonomic keycap arrangement is forced to be sacrificed.

### CROSS-REFERENCE TO RELATED APPLICATIONS

This application claims priority to Chinese Patent Application No. 202620177077.4, filed on Feb. 6, 2026, and entitled “A Foldable Keyboard,” the entire contents of which are incorporated herein by reference.

### TECHNICAL FIELD

The present application belongs to the technical field of electronic products, and particularly relates to a foldable keyboard.

### BACKGROUND

A foldable keyboard is a computer keyboard that can be folded into a smaller size, thereby facilitating carrying and use. A foldable keyboard is usually composed of two or more keyboard bodies connected to each other, and folding is achieved by a hinge or another manner. The foldable keyboard can be used in cooperation with devices such as a laptop computer, a tablet computer, and a smartphone.

However, in existing foldable keyboards, the axis point of a single-axis product theoretically must be higher than the upper planes of two bodies (including keycaps) to achieve 180-degree rotational folding, resulting in a material-thickness portion of a shaft housing other than the axis point protruding beyond the body plane, so that when the foldable keyboard is unfolded for use, the protruding surface portion will come into contact with a user's hand and affect the use feel. Therefore, it is very necessary to design a dual-axis foldable keyboard to solve the above problems.

### SUMMARY

In view of the above problems, the present application provides a foldable keyboard, so as to solve the problems proposed in the above background art.

To achieve the above objective, the present application provides the following technical solution: a foldable keyboard, comprising:
keyboard bodies, wherein two keyboard bodies are provided, the two keyboard bodies are arranged opposite to each other, and one of the keyboard bodies is located on the right side of the other keyboard body;
shaft arms, wherein two shaft arms are provided, a right end of the left keyboard body is connected to one of the shaft arms, a left end of the right keyboard body is connected to the other shaft arm, and the two shaft arms mesh with each other.

Further, the foldable keyboard further comprises:
a shaft bridge, wherein the shaft bridge is located between the two shaft arms, a left end of the shaft bridge is connected to a left end of the left shaft arm, and a right end of the shaft bridge is connected to a right end of the right shaft arm.

Further, the foldable keyboard further comprises:
resilient arms, wherein each of the shaft arms is connected at a lower end thereof to a respective resilient arm, each resilient arm is provided with an upwardly protruding protrusion, convex arcuate surfaces are provided at a lower end of the shaft bridge, and the protrusions are configured to contact the convex arcuate surfaces.

Further, first locking grooves and second locking grooves are formed in the shaft bridge, the first locking grooves and the second locking grooves are respectively located on upper and lower sides of the convex arcuate surfaces, and the protrusions are configured to be inserted into one of the first locking grooves or one of the second locking grooves.

Further, the foldable keyboard further comprises:
pins, wherein each of the pins passes through a corresponding one of the shaft arms and the shaft bridge.

Further, a meshing position of the two shaft arms is located on two sides of the shaft bridge.

Further, one end of each of the two shaft arms is provided with a gear, and the two shaft arms mesh with each other through the gears.

Further, bridge protrusions are provided on one side of the shaft bridge facing the shaft arms; limiting grooves are provided in the gears;
when the foldable keyboard is in an open state, the bridge protrusions are engaged in tooth grooves of the gears;
when the foldable keyboard is in a folded state, the bridge protrusions are engaged in the limiting grooves.

Further, the number of the bridge protrusions is at least two.

Further, the number of the shaft bridges is at least two, the at least two shaft bridges are spaced apart, and the two shaft arms are located between two of the shaft bridges.

The technical effects and advantages of the present application are as follows:
1. Compared with using a single-axis product that causes an upper end of a keyboard to protrude, using meshing connection between two shaft arms can prevent an upper end of the foldable keyboard from protruding, so that the foldable keyboard is relatively convenient to use in an unfolded state.
2. Compared with a hinge product using a single axis, which requires sacrificing a normal ergonomic keycap arrangement, by using dual axes and meshing connection between two shaft arms, the folding rotational motion trajectory between two keyboard bodies can be controlled to be stable, and the normal ergonomic keycap arrangement does not need to be sacrificed, which is conducive to further improving convenience in use.

Other features and advantages of the present application will be set forth in the following description, and, in part, will become apparent from the description, or will be understood by implementing the present application. The objectives and other advantages of the present application can be realized and obtained by the structures indicated in the description and the drawings.

### BRIEF DESCRIPTION OF THE DRAWINGS

To describe the technical solutions in the embodiments of the present application or in the prior art more clearly, the drawings required in the description of the embodiments or the prior art are briefly introduced below. Obviously, the drawings described below are some embodiments of the present application. For a person of ordinary skill in the art, other drawings may also be obtained based on these drawings without creative efforts.

FIG. 1 shows a schematic structural view of a foldable keyboard according to an embodiment of the present application;

FIG. 2 shows a use-state view of the foldable keyboard according to an embodiment of the present application;

FIG. 3 shows a schematic structural view of a keyboard body according to an embodiment of the present application;

FIG. 4 shows a schematic structural view of a shaft arm and a shaft bridge according to an embodiment of the present application;

FIG. 5 shows a schematic structural view of the shaft arm according to an embodiment of the present application;

FIG. 6 shows a schematic structural view of the shaft bridge according to an embodiment of the present application;

FIG. 7 shows a schematic structural view of a shaft arm and a shaft bridge according to another embodiment of the present application;

FIG. 8 shows an exploded schematic view of the shaft arm and the shaft bridge in FIG. 7;

FIG. 9 shows an operational schematic view of the shaft arm and the shaft bridge in FIG. 7;

FIG. 10 shows a schematic structural view of a shaft arm and a shaft bridge according to yet another embodiment of the present application;

FIG. 11 shows an exploded schematic view of the shaft arm and the shaft bridge in FIG. 10.

Reference signs: 1, keyboard body; 2, shaft arm; 3, mounting groove; 4, gear; 41, limiting groove; 5, shaft bridge; 51, bridge protrusion; 6, resilient arm; 7, convex arcuate surface; 8, protrusion; 9, first locking groove; 10, second locking groove; 11, pins; 12, first connecting hole; 13, second connecting hole.

### DETAILED DESCRIPTION OF EMBODIMENTS

To make the objectives, technical solutions, and advantages of the embodiments of the present application clearer, the technical solutions in the embodiments of the present application will be clearly and completely described below with reference to the drawings in the embodiments of the present application. Obviously, the described embodiments are some embodiments of the present application, rather than all embodiments. Based on the embodiments of the present application, all other embodiments obtained by a person of ordinary skill in the art without creative efforts shall fall within the protection scope of the present application.

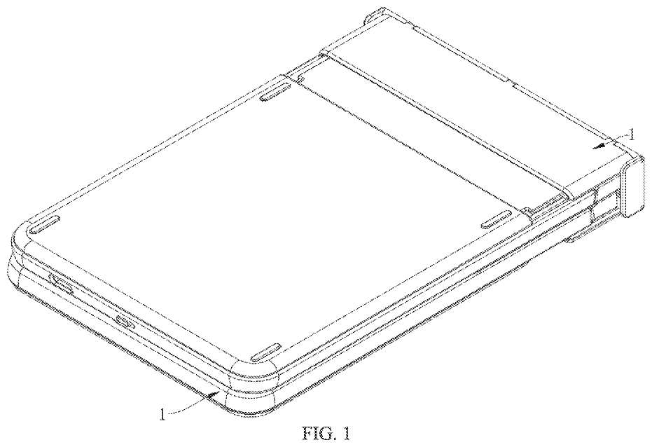

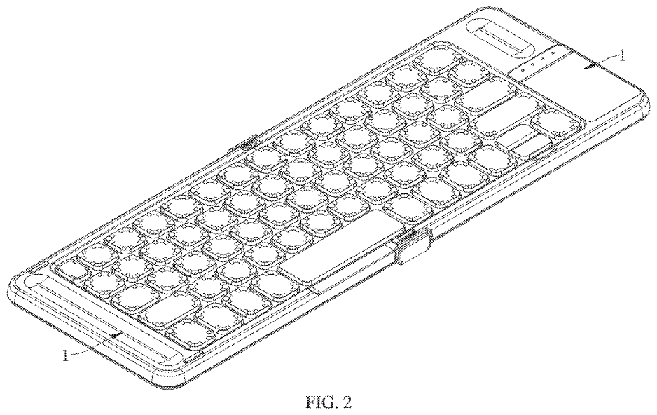

As shown in FIGS. 1 to 5, a foldable keyboard according to an embodiment of the present application comprises keyboard bodies 1 and shaft arms 2. Two keyboard bodies 1 are provided, and the two keyboard bodies 1 are arranged opposite to each other, with one of the keyboard bodies 1 located on the right side of the other keyboard body 1. Two shaft arms 2 are provided, a right end of the left keyboard body 1 is connected to one of the shaft arms 2, a left end of the right keyboard body 1 is connected to the other shaft arm 2, and the two shaft arms 2 mesh with each other.

Specifically, by using meshing connection between the two shaft arms 2, the two shaft arms 2 can rotate relative to each other. Since the two shaft arms 2 are respectively connected to the two keyboard bodies 1, the two shaft arms 2 can drive the two keyboard bodies 1 to rotate relative to each other during relative rotation of the two shaft arms 2. Compared with using a single-axis product that causes an upper end of a keyboard to protrude, using meshing connection between the two shaft arms 2 can prevent an upper end of the foldable keyboard from protruding, so that the foldable keyboard is relatively convenient to use in an unfolded state.

In addition, in the prior art, a hinge product using dual axes uses two rotating shafts passing through the keyboard bodies 1, and a spacing between the two keyboard bodies 1 is relatively large, so that a normal ergonomic keycap arrangement needs to be sacrificed. However, by using meshing connection between the two shaft arms 2, the spacing between the two keyboard bodies 1 can be controlled, and the normal ergonomic keycap arrangement does not need to be sacrificed, which is conducive to further improving convenience in use.

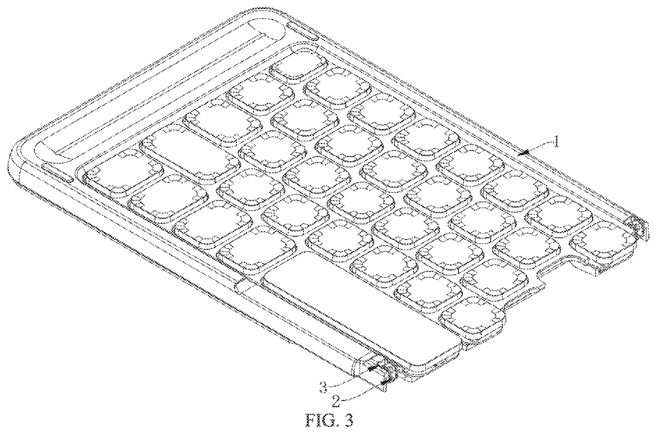

In this embodiment, as shown in FIGS. 3 to 5, mounting grooves 3 are formed at front and rear side edges of the right end of the left keyboard body 1, and mounting grooves 3 are formed at front and rear side edges of the left end of the right keyboard body 1.

In addition, the foldable keyboard further comprises gears 4, and an end portion of each shaft arm 2 is connected to a gear 4.

In addition, a shaft arm 2 is connected to an edge of the right end of the left keyboard body 1, and the gear 4 correspondingly connected to the left shaft arm 2 is located in the mounting groove 3 at the edge of the right end of the left keyboard body 1. A shaft arm 2 is connected to an edge of the left end of the right keyboard body 1, and the gear 4 correspondingly connected to the right shaft arm 2 is located in the mounting groove 3 at the edge of the left end of the right keyboard body 1. The left and right gears 4 mesh with each other. When the two keyboard bodies 1 are placed horizontally opposite to each other, the mounting grooves 3 on the two keyboard bodies 1 are combined into a relatively large mounting groove 3.

In addition, the front and rear sides of the edge of the right end of the left keyboard body 1 are each connected to a shaft arm 2 and provided with a mounting groove 3. The front and rear sides of the edge of the left end of the right keyboard body 1 are each connected to a shaft arm 2 and provided with a mounting groove 3.

In addition, the gear 4 may be integrally formed with the shaft arm 2.

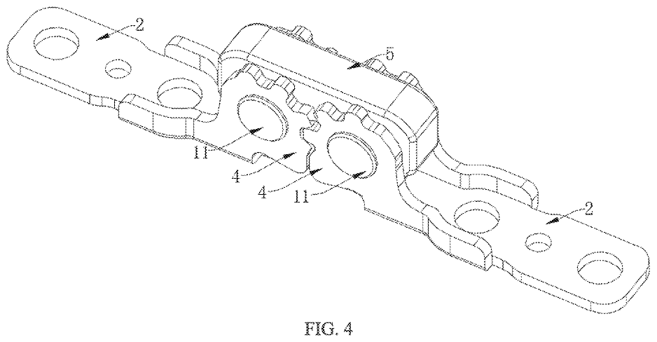

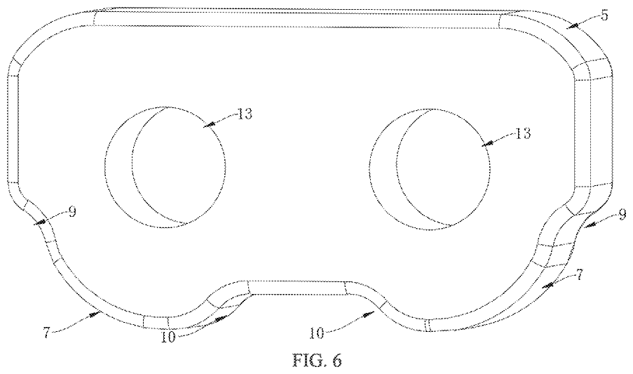

As shown in FIGS. 4 and 6, optionally, the foldable keyboard further comprises a shaft bridge 5. The shaft bridge 5 is located between the two shaft arms 2, a left end of the shaft bridge 5 is connected to a left end of the left shaft arm 2, and a right end of the shaft bridge 5 is connected to a right end of the right shaft arm 2.

Specifically, by using the shaft bridge 5 to connect the two shaft arms 2, the two keyboard bodies 1 can be connected into an integral body.

In this embodiment, the shaft bridge 5 is located in a relatively large mounting groove 3 formed by combining the mounting grooves 3 on the two keyboard bodies 1.

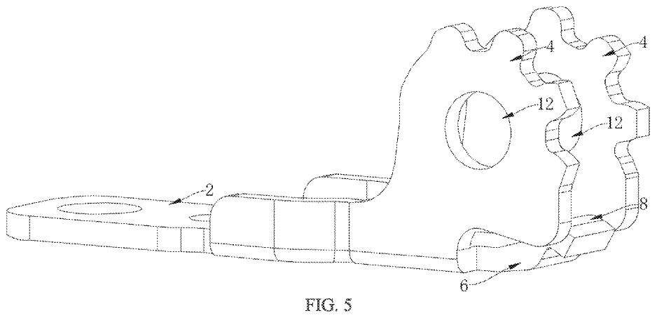

As shown in FIGS. 5 and 6, optionally, the foldable keyboard further comprises resilient arms 6. Each of the shaft arms 2 is connected at a lower end thereof to a respective resilient arm 6, each resilient arm 6 is provided with an upwardly protruding protrusion 8, convex arcuate surfaces 7 are provided at a lower end of the shaft bridge 5, and the protrusions 8 are configured to contact the convex arcuate surfaces 7.

Specifically, by bringing the protrusions 8 on the resilient arms 6 into contact with the convex arcuate surfaces 7, during relative rotation of the two shaft arms 2, the protrusions 8 may apply pressure to the convex arcuate surfaces 7 of the shaft bridge 5 and thereby generate friction, so as to generate a damping feel during rotation.

In this embodiment, the resilient arms 6 may be integrally formed with the shaft arms 2.

As shown in FIG. 6, optionally, first locking grooves 9 and second locking grooves 10 are formed in the shaft bridge 5. The first locking grooves 9 and the second locking grooves 10 are respectively located on upper and lower sides of the convex arcuate surfaces 7, and the protrusions 8 are configured to be inserted into the first locking grooves 9 or the second locking grooves 10.

Specifically, when the two shaft arms 2 are unfolded to a horizontal position, by inserting the protrusions 8 into the second locking grooves 10, stability of the foldable keyboard when unfolded can be ensured. In addition, when the two shaft arms 2 are folded, by inserting the protrusions 8 into the first locking grooves 9, stability of the foldable keyboard after being folded can be ensured.

As shown in FIG. 4, optionally, the foldable keyboard further comprises pins 11, and each of the pins 11 passes through a corresponding one of the shaft arms 2 and the shaft bridge 5.

Specifically, two pins 11 are provided, one of the pins 11 passes through the left shaft arm 2 and a left side portion of the shaft bridge 5, and the other pin 11 passes through the right shaft arm 2 and a right side portion of the shaft bridge 5.

In this embodiment, as shown in FIGS. 4 to 6, first connecting holes 12 are formed in the gears 4, second connecting holes 13 are formed in both left and right side portions of the shaft bridge 5, and the pins 11 sequentially pass through the first connecting holes 12 and the second connecting holes 13.

It can be understood that, in the present application, one end of each shaft arm 2 is connected to a gear 4, and the shaft bridge 5 is located between the gears 4 on the left and right sides, so that the meshing position of the two shaft arms 2 is located on front and rear sides of the shaft bridge 5. The two shaft arms 2 mesh on the front and rear sides of the shaft bridge 5, so that bilateral synchronous transmission can be achieved, the load of single-tooth transmission can be reduced, and the transmission process can be ensured to be smooth and free of jamming.

It can be understood that, in the present application, the shaft arms 2 are connected at lower ends thereof to the resilient arms 6, and the resilient arms 6 are provided with upwardly protruding protrusions 8, which is a preferred embodiment of the present application. In other embodiments, the shaft arms 2 may also not have the resilient arms 6 and the protrusions 8, and the foldable keyboard can also operate.

It can be understood that, in the present application, the meshing position of the two shaft arms 2 being located on the front and rear sides of the shaft bridge 5 is a preferred embodiment of the present application. The two shaft arms 2 may also mesh at a position on one side of the shaft bridge 5, and the foldable keyboard can also operate.

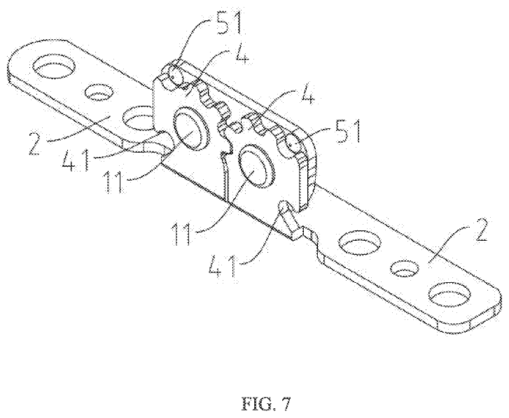

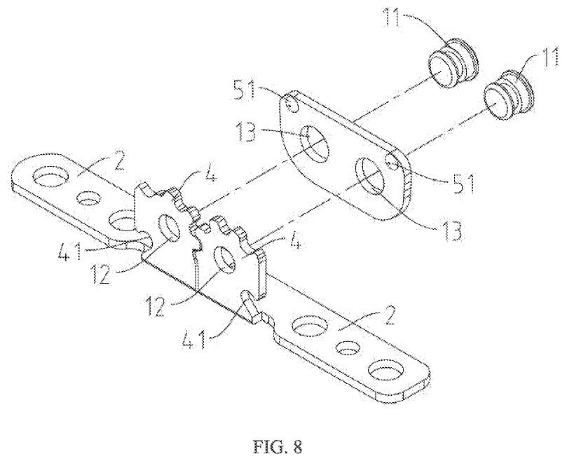

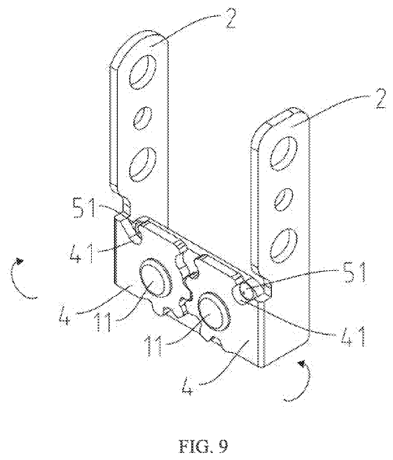

Please further refer to FIGS. 7 to 9. Taking, as an example, the shaft arms 2 meshing at a position on one side of the shaft bridge 5 without involving resilient arms 6, in this embodiment, a left end of the shaft bridge 5 is connected to the left shaft arm 2, a right end of the shaft bridge 5 is connected to the right shaft arm 2, the left shaft arm 2 and the right shaft arm 2 are located on the same side of the shaft bridge 5, and the left shaft arm 2 and the right shaft arm 2 mesh with each other through the gears 4 thereon. The pins 11 are inserted through the first connecting holes 12 in the gears 4 and the second connecting holes 13 in the shaft bridge 5, so that the shaft arms 2 are rotatably connected to the shaft bridge 5.

When a user folds the keyboard, the two keyboard bodies move toward each other, and the two shaft arms 2 are driven to move toward each other through mutual meshing of the gears 4, so that the rotational motion trajectory is stable.

It can be understood that, as a preferred embodiment of the present application, bridge protrusions 51 are provided on one side of the shaft bridge 5 facing the shaft arms 2. Limiting grooves 41 are provided in the gears 4.

When the user normally opens the keyboard, the bridge protrusions 51 are engaged in tooth grooves of the gears 4; when the user folds the keyboard, the bridge protrusions 51 are disengaged from the tooth grooves of the gears 4 and are finally engaged in the limiting grooves 41.

Specifically, the number of the bridge protrusions 51 is two. When the foldable keyboard is in the open state, one of the bridge protrusions 51 is engaged in a tooth groove of the gear 4 on the left shaft arm 2, and the other one is engaged in a tooth groove of the gear 4 on the right shaft arm 2.

Through cooperation between the bridge protrusions 51 and the limiting grooves 41 and cooperation between the bridge protrusions 51 and the tooth grooves, positioning of the foldable keyboard in the open state and the folded state can be facilitated, and corresponding angles of the foldable keyboard in the open state and the folded state can also be controlled through the design of included angles between the limiting grooves 41 and the tooth grooves.

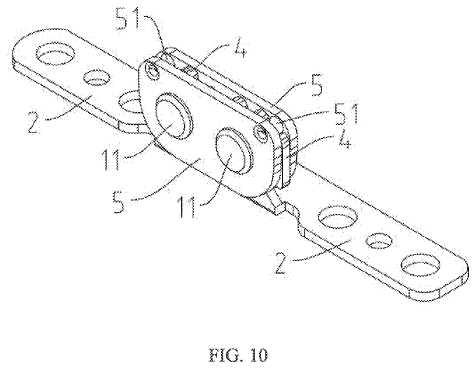

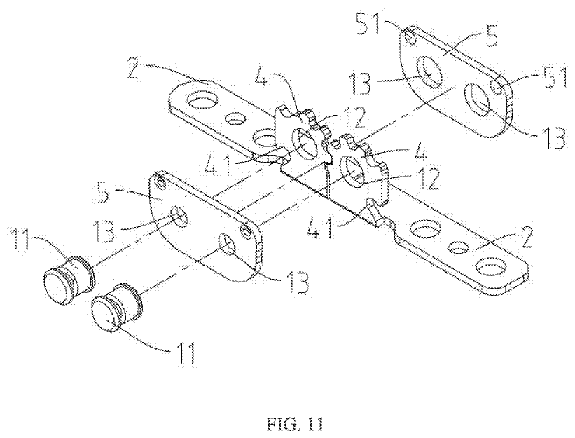

Please further refer to FIGS. 10 to 11. It can be understood that, as a preferred embodiment of the present application, the foldable keyboard further comprises another shaft bridge 5. At this time, the two shaft bridges 5 are spaced apart, and the shaft arms 2 are located between the two shaft bridges 5. At this time, the pins 11 are sequentially inserted through the second connecting holes 13 in one shaft bridge 5, the first connecting holes 12 in the gears 4, and the second connecting holes 13 in the other shaft bridge 5.

By using the two shaft bridges 5 to at least partially shield the gears 4, the gears 4 are protected, interference during meshing of the gears 4 is reduced, and the transmission process can be further ensured to be smooth and free of jamming.

It can be understood that the other shaft bridge 5 is also provided with bridge protrusions 51. Both of the two shaft bridges 5 are provided with bridge protrusions 51, so that the positioning effect of the foldable keyboard in the open state and the folded state can be further enhanced.

It can be understood that, in the present application, the two shaft arms 2 are provided to be connected to each other in meshing engagement so as to form a dual-axis structure. Compared with a single-axis product in which a single axis must be on the two keyboard bodies to achieve 180-degree folding, and compared with hinge-related products in the prior art that have dual axes but do not have gear meshing and thus have poor synchronization between two bodies during folding rotation, in the present solution, a dual-axis synchronized rotating shaft with gear meshing is provided. Since dual-gear meshing is provided, the two bodies are kept moving and rotating for folding synchronously at a consistent angle, so that protrusion beyond the plane can be avoided while the normal ergonomic keycap arrangement is maintained, and the dual-axis structure of the dual-axis product can be hidden in the keyboard bodies 1.

Further, using meshing connection between the two shaft arms 2 enables synchronization to be ensured during folding rotation. Relative misalignment of the keyboard bodies 1 caused by asynchronous rotation of the left and right sides is avoided, thereby preventing the normal arrangement of the keycap array from being displaced or interfered with.

Compared with a hinge product using a single axis, in which the axis point theoretically must be higher than the upper planes of the two bodies (including keycaps) to achieve 180-degree rotational folding, resulting in a material-thickness portion of a shaft housing other than the axis point protruding beyond the body plane, so that when the foldable keyboard is unfolded for use, the protruding surface portion will come into contact with a user's hand, and in which, meanwhile, due to poor synchronization between the two keyboard bodies 1 during folding rotation, the two keyboard bodies 1 cannot be kept moving and rotating for folding synchronously at a consistent angle, and a normal ergonomic keycap arrangement needs to be sacrificed, by using dual axes and meshing connection between the two shaft arms, the folding rotational motion trajectory between the two keyboard bodies can be controlled to be stable, and the normal ergonomic keycap arrangement does not need to be sacrificed, which is conducive to further improving convenience in use.

Although the present application has been described in detail with reference to the foregoing embodiments, a person of ordinary skill in the art should understand that the technical solutions described in the foregoing embodiments may still be modified, or some technical features thereof may be equivalently replaced; and such modifications or replacements do not cause the essence of the corresponding technical solutions to depart from the spirit and scope of the technical solutions of the embodiments of the present application.

What is claimed is:

1. A foldable keyboard, comprising:
keyboard bodies, wherein two keyboard bodies are provided, the two keyboard bodies are arranged opposite to each other, and one of the keyboard bodies is located on the right side of the other keyboard body;
shaft arms, wherein two shaft arms are provided, a right end of the left keyboard body is connected to one of the shaft arms, a left end of the right keyboard body is connected to the other shaft arm, and the two shaft arms mesh with each other.

2. The foldable keyboard according to claim 1, further comprising:
at least one shaft bridge, wherein the shaft bridge is located between the two shaft arms, a left end of the shaft bridge is connected to a left end of the left shaft arm, and a right end of the shaft bridge is connected to a right end of the right shaft arm.

3. The foldable keyboard according to claim 2, further comprising:
resilient arms, wherein each of the shaft arms is connected at a lower end thereof to a respective resilient arm, each resilient arm is provided with an upwardly protruding protrusion, convex arcuate surfaces are provided at a lower end of the shaft bridge, and the protrusions are configured to contact the convex arcuate surfaces.

4. The foldable keyboard according to claim 3, wherein first locking grooves and second locking grooves are formed in the shaft bridge, the first locking grooves and the second locking grooves are respectively located on upper and lower sides of the convex arcuate surfaces, and the protrusions are configured to be inserted into the first locking grooves or the second locking grooves.

5. The foldable keyboard according to claim 2, further comprising:
pins, wherein each of the pins passes through a corresponding one of the shaft arms and the shaft bridge.

6. The foldable keyboard according to claim 2, wherein a meshing position of the two shaft arms is located on two sides of the shaft bridge.

7. The foldable keyboard according to claim 2, wherein one end of each of the two shaft arms is provided with a gear, and the two shaft arms mesh with each other through the gears.

8. The foldable keyboard according to claim 7, wherein bridge protrusions are provided on one side of the shaft bridge facing the shaft arms; and limiting grooves are provided in the gears;
when the foldable keyboard is in an open state, the bridge protrusions are engaged in tooth grooves of the gears;
when the foldable keyboard is in a folded state, the bridge protrusions are engaged in the limiting grooves.

9. The foldable keyboard according to claim 8, wherein the number of the bridge protrusions is at least two.

10. The foldable keyboard according to claim 2, wherein the number of the shaft bridges is at least two, the at least two shaft bridges are spaced apart, and the two shaft arms are located between two of the shaft bridges.
